(19) United States
(12) Patent Application Publication
(10) Pub. No.: US 2002/0101312 A1
(43) Pub. Date: Aug. 1, 2002

(54) Shielded proximity switch encapsulated in a plastics housing

(76) Inventors: Herbert Sowa, Schwarzenberg (DE); Jens Muller, Schwarzenberg (DE)

Correspondence Address: Martin A. Farber, Suite 473, 866 United Nations Plaza, New York, NY, 10017, US

(21) Appl. No.: 10/013,313

(22) Filed: Nov. 5, 2001

(30) Foreign Application Priority Data
Nov. 17, 2000 (DE) 200 19 542.5

(51) Int. Cl. H01H 9/00

(52) U.S. Cl. 335/205

(57) ABSTRACT

Proximity switch which is encapsulated in a plastics housing and has a coil, which is supported by a coil former (2), and a plate which bears the coil former (2), wherein the, particularly exposed, coil is shielded by a metal-coated or metallic nonwoven, woven fabric or metallized film or foil.

The invention relates to a proximity switch which is encapsulated in a plastics housing and has a coil and a plate.

Proximity switches of this type are known in the prior art. They operate in particular as inductive proximity switches. The coil or coils lie behind an “active face” of the plastics housing, which is the end face thereof. The coil emits an electromagnetic alternating field in a known way. Behind the coil or the coil former bearing the coil there is a plate on which are situated elements of the resonant circuit which serves to generate the electromagnetic alternating field. Furthermore, the known evaluation circuit assemblies are situated on the plate.

Exposed coils of this type, i.e. coils without a ferrite core, are highly susceptible to interference.

The invention is therefore based on the object of providing means which, in a simple way, can make a proximity switch of the generic type less susceptible to inference.

The object is achieved by the invention provided in the claims.

Claim 1 provides for the coil to be shielded by a metal-coated or metallic nonwoven, woven fabric or a metallized film or foil. This nonwoven, woven fabric or the metallized film or foil has the property of shielding the coil from interference as a result of the metallization structure. However, the shielding material is also sufficiently transmissive to the electromagnetic alternating field which is generated by the coil to ensure the switching capacity of the proximity switch. In a preferred configuration of the invention, the nonwoven or woven fabric comprises a planar blank. This blank has a central region which shields the end face of the coil former. Periphery sections, which complement one another to form a shape which shields the coil wall, in particular a cylindrical shape, protrude from this central region. The number of periphery sections which protrude directly from the central region is preferably twice as high as the number of nonwoven sections which line the inner wall of the cap at a spacing from the central region.

In a preferred configuration, there is a total of eight periphery sections which protrude radially from the central region. The periphery sections are of substantially triangular form. They have edges which either diverge or converge. They are arranged in such a way that periphery sections with diverging edges and periphery sections with converging edges alternate with one another. The diverging periphery sections merge into rectangular sections which, in the assembled state, lying in the remote position from the central region, form the shape of a cylinder sleeve.

In a refinement of the invention, there is a hole disposed in the central region. This hole is disposed in such a way that it lies above a coil cutout. It therefore serves as a centring aid. Furthermore, the hole also has another technical function. If the proximity switch is to be potted, the potting compound can penetrate through this hole from the outside into the coil former. The nonwoven is preferably produced from a polyester material and coated with a metal. The coating may take place in vacuo. The nonwoven is preferably coated with aluminium.

An exemplary embodiment of the invention is explained below with reference to the appended drawings, in which:

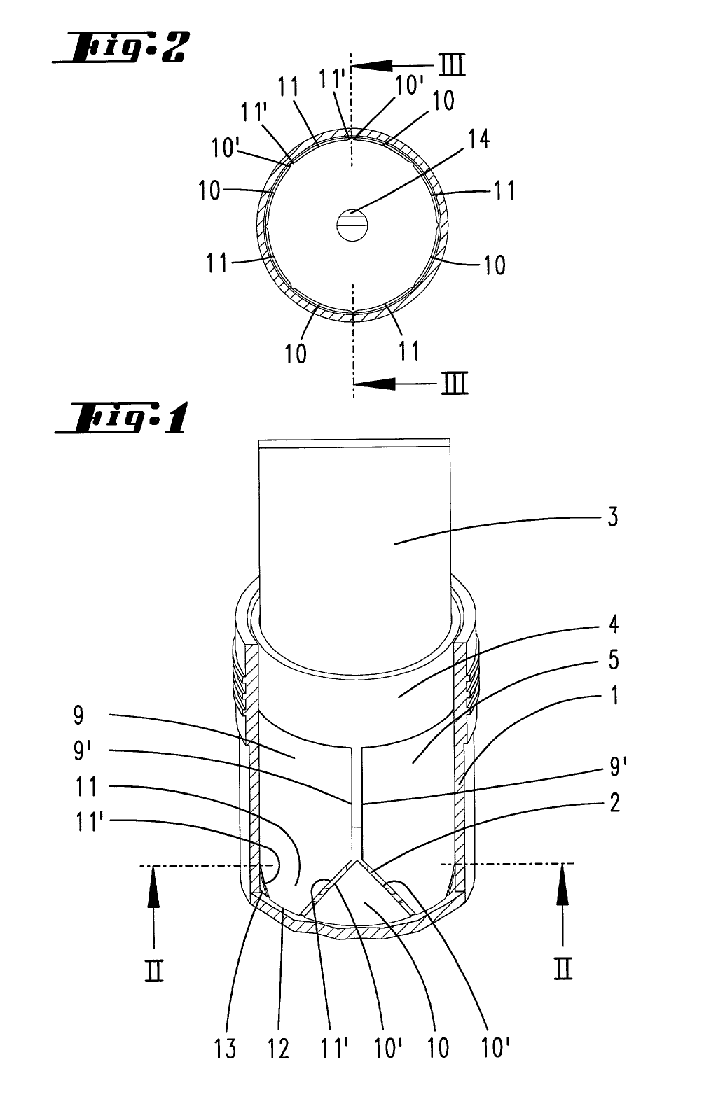

FIG. 1 shows a perspective view, with the cap partially cut away, of an exemplary embodiment of the proximity switch,

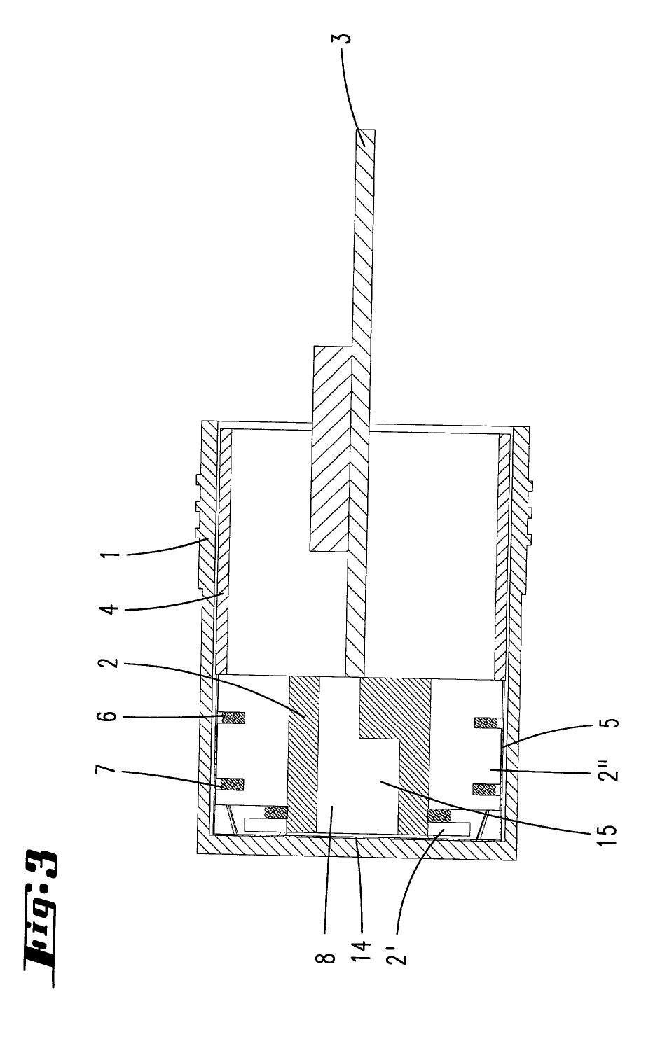

FIG. 2 shows a section on line II-II in FIG. 1,

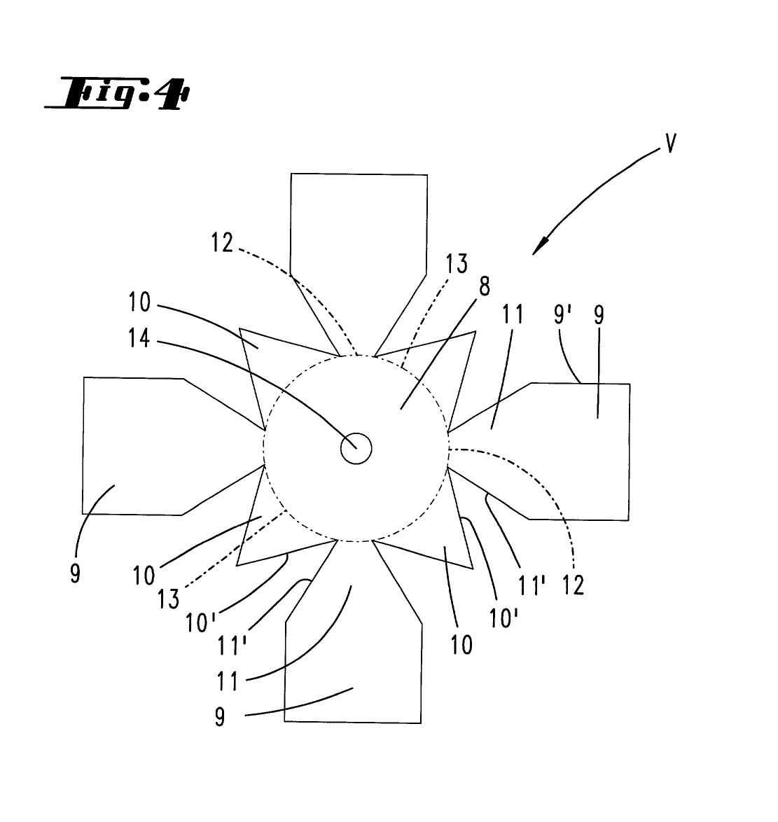

FIG. 3 shows a section on line III-III in FIG. 2, and

FIG. 4 shows the nonwoven blank.

The proximity switch has a plastics cap with a cylindrical cross-sectional shape. The cap has a circular end face, which is the “active face” of the proximity switch. In the plastics cap 1 there is an assembly which comprises a coil former 2 and a plate arranged behind it. The coil former 2 is made from plastics. It has circumferential slots in which the coils 6, 7 are wound. The evaluation electronics and/or a circuit for supplying the coils 6, 7 with a high-frequency signal is/are situated on the rear plate 3.

Furthermore, to the rear of the coil former 2 there is a metal ring 4, the external diameter of which is slightly smaller than the internal diameter of the cap 1.

The blank illustrated in FIG. 4 consists of a polyester nonwoven which is coated with aluminium. The blank has a central region 8 which has a hole 14 in its center. In the assembled proximity switch, the central region 8 rests with surface-to-surface contact on the end face 2′ of the coil former, so that the hole 14 is aligned with a central cutout 15 in the coil former. The central region 8 is formed by a fold edge 18. This is an “imaginary fold edge”. This edge is the line about which the periphery sections 10, 11 of the blank 5 fold when the coil former 2 and plate 3 together with the shielding nonwoven 5 are inserted into the plastics cap 1.

In total, there are two differently configured types of periphery sections 10, 11. A first type of periphery sections 10 has converging edges 10′. These edges 10′ originate from the fold edge 13 in a remote position from one another and run towards one another in the shape of a triangle. There are in total four converging periphery sections 10 of this type. Between these converging periphery sections 10 there are diverging periphery sections 11. The edges 11′ of these periphery sections 11 originate from the fold edge 13 at a short distance from one another and form a trapezium-shaped section 11. At the base of the trapezium, this periphery section 11 continues into a rectangular section 9.

To assemble the proximity switch, firstly a potting compound is introduced into the empty plastics cap 1. Then, the shielding nonwoven 5 is laid onto the opening in the cap 1, in such a manner that the central region 8 covers the opening. Then, the coil former 2, with its cutout 15 aligned with the hole 14, is placed onto the central region 8 and is pushed into the opening in the cap. In the process, the periphery sections 10, 11 position themselves around the imaginary fold edge 13, so that the edges 10′ of the converging periphery sections come to bear with edge-to-edge contact against the adjacent edges 11′ of the diverging periphery sections 11. The edges 9′ of the rectangular sections 9 which adjoin the diverging periphery sections 11 also come to bear against one another substantially without any gaps, so that overall a cup-like lining of the cavity of the plastics cap 1 by a metallized shielding nonwoven is produced.

When this unit is pressed into the potting compound, the potting compound can penetrate through the opening 14 into the coil-former cutout 15.

The section of the plate 3 which extends to the rear of the coil former 2 is surrounded by a metal ring 4, against the outer wall of which the rectangular sections 9 of the nonwoven 5 position themselves in such a manner that it rests tightly between metal-ring outer wall and cap inner wall.

Electrical contact with the shielding material may also be made by means of a conductive adhesive. The shielding material used is preferably an aluminium nonwoven. However, it is also possible to use a metallized or metal woven fabric or a metallized or metal film or foil.

All features disclosed are (inherently) pertinent to the invention. The content of disclosure of the associated/appended priority documents (copy of the prior application) is hereby incorporated in its entirety in the disclosure of the application, partly for the purpose of incorporating features of these documents in claims of the present application.

1. Proximity switch which is encapsulated in a plastics housing and has a coil, which is supported by a coil former (2), and a plate which bears the coil former (2), characterized in that the, in particular exposed, coil is shielded by a metal-coated or metallic nonwoven, woven fabric or metallized film or foil.

2. Proximity switch according to one or more of the preceding claims or in particular according thereto, characterized in that the nonwoven, woven fabric, film or foil is a blank, the central region (8) of which shields the end face (2′) of a coil former (2) and the periphery sections (10, 11) of which, which sections protrude from the central region (8), complement one another to form a shape which shields the coil wall (2′), in particular a cylindrical shape.

3. Proximity switch according to one or more of the preceding claims or in particular according thereto, characterized in that the number of the periphery sections (10, 11) which protrude directly from the central region is twice as high as the number of nonwoven sections (9) which line the inner wall of the cap (1) at a spacing from the central region.

4. Proximity switch according to one or more of the preceding claims or in particular according thereto, characterized by eight periphery sections (10, 11) which have alternately diverging and converging edges (10′, 11′).

5. Proximity switch according to one or more of the preceding claims or in particular according thereto, characterized in that the diverging periphery sections (11) merge into rectangular sections (9).

6. Proximity switch according to one or more of the preceding claims or in particular according thereto, characterized by a hole (14) which is provided in the central region (8) and lies above a coil-former cutout (15).

7. Proximity switch according to one or more of the preceding claims or in particular according thereto, characterized in that the shielding material is a nonwoven, a woven fabric or a plastics film, in particular consists of polyester and is coated with metal.

8. Proximity switch according to one or more of the preceding claims or in particular according thereto, characterized in that the plastics nonwoven or the film or foil is coated with aluminium.

9. Proximity switch according to one or more of the preceding claims or in particular according thereto, characterized in that the shielding material is electrically connected to the electronic circuit earth by means of the metal ring.

10. Proximity switch according to one or more of the preceding claims or in particular according thereto, characterized in that the shielding material is electrically connected to the electronic circuit earth by means of a conductive adhesive.
